(19) United States
(12) Patent Application Publication
(10) Pub. No.: US 2026/0122132 A1
(43) Pub. Date: Apr. 30, 2026

(54) SERVER SYSTEM, DATA PROCESSING METHOD AND APPARATUS, DEVICE, AND MEDIUM

(71) Applicant: IEIT SYSTEMS (BEIJING) CO., LTD., Beijing (CN)

(72) Inventors: Yanwei WANG, Beijing (CN); Cheng HUANG, Beijing (CN); Jiaheng FAN, Beijing (CN)

(21) Appl. No.: 19/469,932

(22) PCT Filed: Dec. 5, 2024
(86) PCT No.: PCT/CN2024/137228

§ 371 Date: Sep. 26, 2025

(30) Foreign Application Priority Data
Dec. 28, 2023 (CN) 202311843331.7

(51) Int. Cl. H04L 67/1097

(52) U.S. Cl. CPC H04L 67/1097

(57) ABSTRACT

The present application discloses a server system, a data processing method, an apparatus and a device and a medium, relating to the field of computer technology. The server system comprises a network interface card, a processor and an accelerator connected to the network interface card. The first remote direct data access processing unit in the network interface card is configured to receive a remote direct data access request and forward the remote direct data access request to the processor or the accelerator. The processor is configured to cache data in the network interface card through communication between the second compute express link controller and the first compute express link controller, and process received remote direct data access request based on the data by using a second remote direct data access processing unit. The accelerator is configured to cache the data in the network interface card through communication between a third compute link express controller and the first compute express linkd controller, and process the received remote direct data access request based on the data by using the third remote direct data access processing unit.

### CROSS-REFERENCE TO RELATED APPLICATION

The present application claims the priority of Chinese patent application filed in CNIPA on Dec. 28, 2023, with the present application number of 202311843331.7 and the present application name of “SERVER SYSTEM, DATA PROCESSING METHOD AND APPARATUS, DEVICE, AND MEDIUM”, the entire contents of which are incorporated into the present application by reference.

### FIELD

The present application relates to the technical field of computers, and more specifically relates to a server system, a data processing method, an apparatus, a device and a medium.

### BACKGROUND

Unlike traditional software-based TCP (Transmission Control Protocol) transmission, RDMA (Remote Direct Memory Access) is a hardware-based transmission technology that fully implements transport functions, including congestion control and packet loss recovery within a NIC (Network Interface Card) hardware. It provides user applications with kernel bypass and zero-copy interfaces. As a result, compared to software-based TCP, RDMA achieves high throughput, low latency, and low CPU (Central Processing Unit) overhead. RDMA is typically fully offloaded to a hardware, so its parallelism and processing capacity are limited by amount of available hardware resources. Once the hardware resources on an RNIC (RDMA-enabled Network Interface Card) are exhausted, RDMA will reach a bottleneck in performance and processing, with no possibility of capacity expansion.

In related arts, there are several solutions for capacity expansion of RNIC: the first solution is to replace the RNIC with a more powerful one. A more powerful RNIC has more hardware resources and may provide larger RDMA business capacity, for example, replacing a 4060 graphics card with a 4090 graphics card. The second solution is to insert multiple RNICs, for example, replacing one 4060 graphics card with two 4060 graphics cards. It may be seen that the capacity expansion of RNIC solutions in related arts require hardware replacement, which brings upgrade costs and lacks flexibility. For example, when only a short period of time requires a larger RDMA business capacity, upgrading the hardware lacks flexibility, resulting in the RNIC not being fully loaded for most of the time.

### SUMMARY

The purpose of the present application is to provide a server system, a data processing method, an apparatus, a device and a medium, and realize flexible capacity expansion of RNIC.

In order to achieve above purpose, the present application provides a server system, including a network interface card, a processor and an accelerator, connected to the network interface card, wherein the network interface card includes a first remote direct memory access processing unit and a first compute express link controller, the processor includes a second remote direct memory access processing unit and a second compute express link controller, and the accelerator includes a third remote direct memory access processing unit and a third compute express link controller;
the first remote direct memory access processing unit in the network interface card, configured to receive a remote direct memory access request and forward the remote direct memory access request to the processor or the accelerator;
the processor, configured to obtain target data from the network interface card through communication between the second compute express link controller and the first compute express link controller, and process received remote direct memory access request based on the target data by using the second remote direct memory access processing unit;
the accelerator, configured to obtain target data from the network interface card through communication between the third compute express link controller and the first compute express link controller, and process the received remote direct memory access request based on the target data by using the third remote direct memory access processing unit.

The first remote direct memory access processing unit is specifically configured to receive a remote direct memory access request, determine whether capacity expansion is required according to the remote direct memory access request, and if capacity expansion is required, forward the remote direct memory access request to the processor or the accelerator.

The first remote direct memory access processing unit is further configured to process the remote direct memory access request based on internally cached data in response to determining that capacity expansion is not required according to the remote direct memory access request.

The first remote direct memory access processing unit forwards the remote direct memory access request to the second remote direct memory access processing unit in the processor by means of software messages.

The first remote direct memory access processing unit forwards the remote direct memory access request to the third remote direct memory access processing unit in the accelerator by means of doorbell.

The third remote direct memory access processing unit is a remote direct memory access processing unit implemented by a field programmable gate array or an artificial intelligence dedicated processor.

The network interface card is further configured to: forward congestion management tasks and/or queue pair context management tasks to the processor or the accelerator;
the processor is further configured to process received congestion management tasks and/or queue pair context management tasks by using the second remote direct memory access processing unit;
the accelerator is further configured to process received congestion management tasks and/or queue pair context management tasks by using the third remote direct memory access processing unit.

The target data is data with a volume less than a preset value and/or an access frequency greater than a preset access frequency.

The network interface card includes:
a capacity expansion management of remote direct memory access unit, configured to determine whether capacity expansion is required according to the remote direct memory access request;
a processor agent unit, configured to forward the remote direct memory access request to the processor when the capacity expansion is required;
an accelerator agent unit configured to forward the remote direct memory access request to the accelerator when the capacity expansion is required;
a network interface card operation of remote direct memory access unit, configured to process the remote direct memory access request based on internally cached data when the capacity expansion is not required;
a compute express link device management unit, configured to manage compute express link devices in the network interface card;
a compute express link driver, configured to perform startup and operation of the compute express link devices in the network interface card.

In order to achieve above purpose, the present application provides a data processing method, applied to the network interface card in the server system as mentioned above, including:
receiving a remote direct memory access request;
forwarding the remote direct memory access request to a processor or an accelerator in the server system, so that the processor or accelerator obtains target data from the network interface card by compute express link, and process the received remote direct memory access request based on the target data.

After receiving the remote direct memory access request, the method further includes:
determining whether capacity expansion is required according to the remote direct memory access request;
if capacity expansion is required, executing a step of forwarding the remote direct memory access request to the processor or the accelerator in the server system.

After determining whether capacity expansion is required according to the remote direct memory access request, the method further includes:
in response to determining that capacity expansion is not required according to the remote direct memory access request, processing the remote direct memory access request based on the internally cached data.

Forwarding the remote direct memory access request to the processor in the server system includes:
forwarding the remote direct memory access request to the processor in the server system by means of software messages.

Forwarding the remote direct memory access request to an accelerator in the server system includes:
forwarding the remote direct memory access request to the accelerator in the server system by means of doorbell.

In order to achieve above purpose, the present application provides a data processing apparatus, applied to the network interface card in the server system as mentioned above, including:
a receiving module, configured to receive a remote direct memory access request;
a forwarding module, configured to forward the remote direct memory access request to a processor or an accelerator in the server system, so that the processor or the accelerator caches data in the network interface card through compute express link, and processes the received remote direct memory access request based on the data.

Among them, the apparatus further includes:
a determination module, configured to determine whether capacity expansion is required according to the remote direct memory access request; if capacity expansion is required, start a workflow of the forwarding module; if capacity expansion is not required, start a workflow of the processing module;
a processing module, configured to process the remote direct memory access request based on internally cached data.

The forwarding module is specifically configured to forward the remote direct memory access request to the processor in the server system by means of software messages.

The forwarding module is specifically configured to forward the remote direct memory access request to the accelerator in the server system by means of doorbell.

In order to achieve above purpose, the present application provides an electronic device, including:
a memory, configured to store a computer program;
a processor, configured to implement steps of the data processing method as mentioned above when executing the computer program.

In order to achieve above purpose, the present application provides a non-transitory computer readable storage medium, wherein a computer program is stored on the non-transitory computer readable storage medium, and the computer program, when executed by a processor, implements the steps of the data processing method as mentioned above.

According to the above solution, the present application provides a server system, including a network interface card, a processor and an accelerator, connected to the network interface card, wherein the network interface card includes a first remote direct memory access processing unit and a first compute express link controller, the processor includes a second remote direct memory access processing unit and a second compute express link controller, and the accelerator includes a third remote direct memory access processing unit and a third compute express link controller; the first remote direct memory access processing unit in the network interface card, configured to receive a remote direct memory access request and forward the remote direct memory access request to a processor or an accelerator; the processor, configured to obtain target data from the network interface card through communication between the second compute express link controller and the first compute express link controller, and process received remote direct memory access request based on the target data by using the second remote direct memory access processing unit; the accelerator, configured to obtain target data from the network interface card through communication between the third compute express link controller and the first compute express link controller, and process the received remote direct memory access request based on the target data by using the third remote direct memory access processing unit.

In the present application, remote direct memory access processing units are deployed in processors and accelerators, and when processing capacity of a RNIC is insufficient, a CXL is utilized to cache data from the RNIC to expand the processing capacity of the RNIC. That is to say, the present application offloads part of functions of the RDMA processing units from the RNIC to CPUs and accelerators. Compared to the related art, it eliminates a need to replace or add physical RNICs, enabling flexible scaling of RNIC capacity. The present application also discloses a data processing method, a data processing apparatus, an electronic device and a non-transitory computer readable storage medium, which may also achieve the above technical effects.

It should be understood that both the above general description and the following detailed description are exemplary only and are not restrictive of the present application.

### BRIEF DESCRIPTION OF THE DRAWINGS

In order to more clearly explain embodiments of the present application or technical solutions in the prior art, drawings required to be used in the description of the embodiments or the prior art will be briefly introduced below. Obviously, the drawings in the following description are only some embodiments of the present application, and other drawings may be obtained according to these drawings without creative work for persons skilled in the field. The drawings are provided to provide further understanding of the present disclosure and constitute a part of the specification, and together with the following detailed description, serve to explain the present disclosure, but do not constitute a limitation of the present disclosure. In the drawings:

FIG. 1 is a diagram of an RNIC hardware architecture in related art;

FIG. 2 is a structural diagram of a server system according to some embodiments of the present application;

FIG. 3 is a diagram of an RNIC software architecture according to some embodiments of the present application;

FIG. 4 is a flowchart of a data processing method according to some embodiments of the present application;

FIG. 5 is a flowchart of an application embodiment provided by the present application;

FIG. 6 is a structural diagram of a data processing apparatus according to some embodiments of the present application;

FIG. 7 is a structural diagram of an electronic device according to some embodiments of the present application.

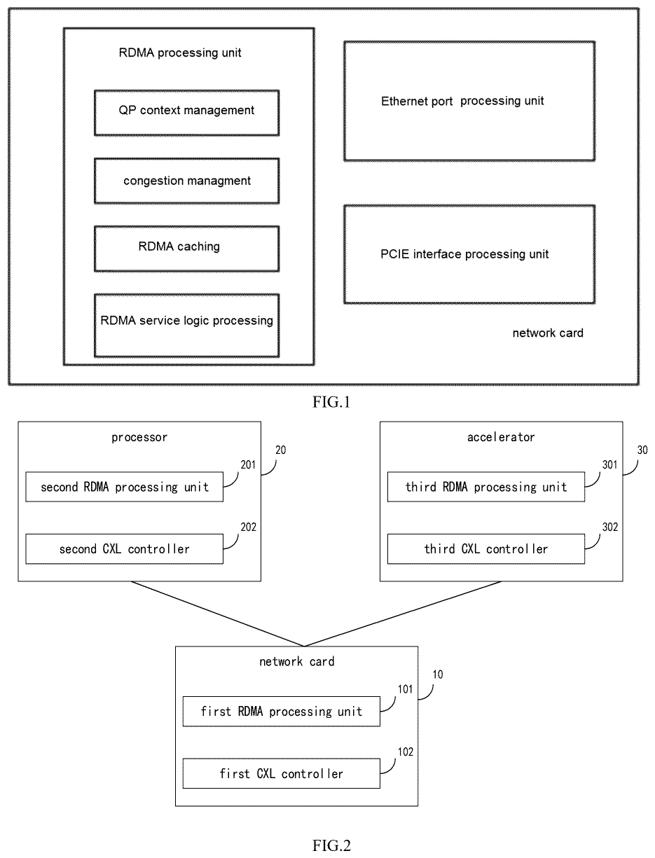

### DETAILED DESCRIPTION

In the following, the technical solutions in the embodiments of the present application will be described clearly and completely with the drawings. Obviously, the described embodiments are only a part of the embodiments of the present application, not all embodiments. Based on the embodiments in the present application, all other embodiments obtained by persons skilled in the field without creative work belong to the protection scope of the present application. In addition, in the embodiments of the present application, “first” and “second” are configured to distinguish similar objects, and are not necessarily configured to describe a specific order or precedence.

In the related art, a hardware architecture of RNIC is shown in FIG. 1, including an RDMA processing unit, a PCIE (Peripheral Component Interconnect Express) interface processing unit and an Ethernet port processing unit. The Ethernet port processing unit is configured to send Ethernet messages. The PCIE interface processing unit is responsible for high-speed connecting between a RNIC and a host. The Ethernet port processing unit and the PCIE interface processing unit are not a bottleneck point of RDMA processing, but the bottleneck point of processing capacity of RDMA primarily lies in the RDMA processing unit. The RDMA processing unit is responsible for QP (Queue Pair, that is, a sending queue and a receiving queue) context management, RDMA congestion management, RDMA caching and RDMA service logic processing in RDMA processing engineering. These processing involve more complicated logic, much more complicated than processing of PCIE and Ethernet port, and will also occupy more computing resources. In the related art, an essential problem that the RNIC may't be expanded is that all the processing capacity is solidified on the RDMA processing unit on the RNIC.

Therefore, in the present application, remote direct memory access processing units are deployed in processors and accelerators, and when processing capacity of RNIC is insufficient, a CXL is utilized to cache data from the RNIC to expand the processing capacity of the RNIC. That is to say, the present application offloads part of functions of the RDMA processing units from the RNIC to CPUs and accelerators. Compared to the related art, it eliminates a need to replace or add physical RNICs, enabling flexible scaling of RNIC capacity.

The embodiment of the present application discloses a server system, which includes a network interface card 10, a processor 20 and an accelerator 30, connected to the network interface card 10, wherein the network interface card 10 includes a first remote direct memory access processing unit 101 and a first compute express link controller 102, the processor 20 includes a second remote direct memory access processing unit 201 and a second compute express link controller 202, and the accelerator 30 includes a third remote direct memory access processing unit 301 and a third compute express link controller 302;

The first remote direct memory access processing unit 101 in the network interface card 10, configured to receive a remote direct memory access request and forward the remote direct memory access request to a processor or an accelerator;

The processor 20, configured to cache data in the network interface card 10 through communication between the second compute express link controller 202 and the first compute express link controller 102, and process received remote direct memory access request based on the data by using the second remote direct memory access processing unit 201;

The accelerator 30, configured to cache the data in the network interface card 10 through communication between the third compute express link controller 302 and the first compute express link controller 102, and process the received remote direct memory access request based on the data by using the third remote direct memory access processing unit 301.

In some embodiments of the present application, the network interface card may be a RNIC, a first compute express link controller is added to the network interface card, a second remote direct memory access processing unit and a second compute express link controller are deployed in the processor, and a third remote direct memory access processing unit and a third compute express link controller are deployed in the accelerator. The second compute express link controller in the processor and the third compute express link controller in the accelerator are configured to obtain target data from the RNIC and cache the target data, and the first compute express link controller in the RNIC cooperates with the second compute express link controller in the processor and the third compute express link controller in the accelerator to complete a CXL function. A reason why the CPUs and accelerators cooperate with the RNIC through CXL is that CXL may improve access performance of the CPUs and accelerators to RNIC data. The accelerator in this embodiment may be a heterogeneous accelerator, and the heterogeneous accelerator is a special accelerator, which adopts various algorithms and architectures to improve computing power.

In some embodiments, the target data is data with a volume less than a preset value and/or an access frequency greater than a preset access frequency. In specific implements, data with a volume less than the preset value may be offloaded to the processor or accelerator to better leverage cache coherence function of CXL. Additionally, data with an access frequency greater than the preset access frequency, that is, hot data, may also be offloaded to the processor or accelerator, such as network protocol data packets and real-time data streams related to real-time network communication, so as to improve accuracy of processing remote direct memory access requests. Apparently, the target data may be the data that simultaneously meets conditions of having the volume less than the preset value and the access frequency greater than the preset access frequency.

The second remote direct memory access processing unit in the processor may be realized by pure software, and the third remote direct memory access processing unit in the accelerator may be realized by hardware, for example, the third remote direct memory access processing unit is realized by a field programmable gate array or an artificial intelligence dedicated processor. The first remote direct memory access processing unit in the network interface card may be an Intellectual Property Core (IP core).

The first remote direct memory access processing unit in the RNIC receives the remote direct memory access request and forwards the remote direct memory access request to the second remote direct memory access processing unit in the processor or the third remote direct memory access processing unit in the accelerator for processing.

In some embodiments, the first remote direct memory access processing unit is specifically configured to receive a remote direct memory access request, determine whether capacity expansion is required according to the remote direct memory access request, forward the remote direct memory access request to the processor or the accelerator if capacity expansion is required, and process the remote direct memory access request based on internally cached data if capacity expansion is not required.

In specific implement, the first remote direct memory access processing unit in the RNIC receives the remote direct memory access request, determines whether capacity expansion is required according to an amount of data to be processed of the remote direct memory access request and load condition of the RNIC, and if the capacity expansion is required, forwards the remote direct memory access request to the second remote direct memory access processing unit in the processor or the third remote direct memory access processing unit in the accelerator for processing, if the capacity expansion is not required, processes the remote direct memory access request based on the internally cached data.

In some embodiments, the first remote direct memory access processing unit forwards the remote direct memory access request to the second remote direct memory access processing unit in the processor by means of software messages.

In some embodiments, the first remote direct memory access processing unit forwards the remote direct memory access request to the third remote direct memory access processing unit in the accelerator by means of doorbell.

In some embodiments, the network interface card is also configured to forward congestion management tasks and/or queue pair context management tasks to the processor or the accelerator; The processor, is further configured to process received congestion management tasks and/or queue pair context management tasks by using the second remote direct memory access processing unit; The accelerator is also configured to process received congestion management tasks and/or queue pair context management tasks by using the third remote direct memory access processing unit.

In specific implement, in addition to offloading RDMA service logic processing tasks of the RNIC, the CPUs and accelerators may also offload the congestion management tasks, queue pair context management tasks, and RDMA caching on the RNIC.

Furthermore, some embodiments of the present application adjust a software architecture of the RNIC. In related arts, an RDMA software architecture includes: an RDMA verbs, an RDMA core and an RDMA driver. Among them, the RDMA verbs is a user-mode library and the RDMA core is a kernel-mode universal library, both of which are provided by an operating system. The RDMA driver is provided by hardware manufacturers, and a driver of RNIC of a big manufacturer is also integrated into the operating system, which is responsible for operation of RNIC registers.

In some embodiments, the network interface card includes capacity expansion management of remote direct memory access unit, which is configured to determine whether capacity expansion is required according to a remote direct memory access request; A processor agent unit is configured to forward the remote direct memory access request to the processor when the capacity expansion is required; An accelerator agent unit is configured to forward the remote direct memory access request to the accelerator when the capacity expansion is required; A network interface card operation of remote direct memory access unit is configured to process the remote direct memory access request based on the the internally cached data when the capacity expansion is not required; A compute express link device management unit is configured to manage compute express link devices in the network interface card; A compute express link driver is configured to perform startup and operation of compute express link devices in the network interface card. Among them, the units mentioned above may be implemented by IP core.

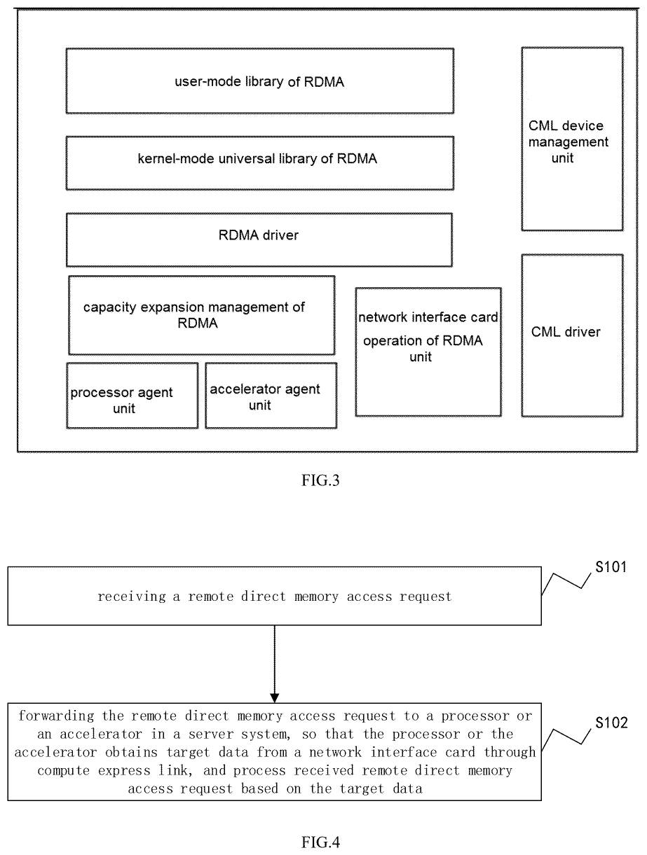

As shown in FIG. 3, a software architecture of RNIC is provided by some embodiments of the present application. Functions of the RDMA driver are divided into: the network interface card operation of remote direct memory access unit, the capacity expansion management of remote direct memory access unit, the processor agent unit and the accelerator agent unit. Among them, the network interface card operation of remote direct memory access unit is responsible for operation of RNIC registers, and processing the remote direct memory access request based on the the internally cached data when capacity expansion is not required. The capacity expansion management of remote direct memory access unit is responsible for determining whether capacity expansion is required according to the remote direct memory access request, and carrying out related capacity expansion work when the processing capacity of RDMA is insufficient. The processor agent unit is responsible for offloading part of functions of RDMA in the RNIC to the CPU, and sending related RDMA requests to the second remote direct memory access processing unit in the processor by means of software messages. The accelerator agent unit is responsible for offloading part of functions of RDMA in the RNIC to the accelerator, and sending related RDMA requests to the third remote direct memory access processing unit in the accelerator by means of the doorbell.

In addition, the software architecture of RNIC also includes a compute express link driver and a compute express link device management unit to assist normal operation of CXL on the CPU, accelerator and RNIC. The compute express link driver is configured to start and operate CXL devices, which is a basis of CXL operation. The compute express link device management unit is configured to perform user management of CXL devices, such as checking running status of CXL devices.

In the embodiment of the present application, a remote direct memory access processing unit is deployed in the processor and the accelerator, and when the processing capacity of the RNIC is insufficient, the data in the RNIC is cached by using CXL to expand the processing capacity of the RNIC. Thus, the embodiment of the present application offloads the part of the functions of the RDMA processing unit in the RNIC to the CPUs and accelerators, and compared with the related art, there is no need to replace or add the RNIC, thus realizing flexible capacity expansion of RNIC.

The embodiment of the present application discloses a data processing method, as shown in FIG. 4, and a flow chart of a data processing method shown in some embodiments of the present application, as shown in FIG. 4, includes:
step S101: receiving a remote direct memory access request;
step S102: forwarding the remote direct memory access request to a processor or an accelerator in a server system, so that the processor or the accelerator may obtain target data from a network interface card through compute express link, and process received remote direct memory access request based on the target data.

An execution subject of this embodiment is the network interface card in the above server system, which supports RDMA function, that is, the network interface card may be a RNIC. The server system includes a network interface card, a processor and an accelerator connected to the network interface card, wherein the network interface card includes a first remote direct memory access processing unit and a first compute express link controller, the processor includes a second remote direct memory access processing unit and a second compute express link controller, and the accelerator includes a third remote direct memory access processing unit and a third compute express link controller. The first compute express link controller is deployed in the network interface card, the second remote direct memory access processing unit and the second compute express link controller are deployed in the processor, and the third remote direct memory access processing unit and the third compute express link controller are deployed in the accelerator. The second compute express link controller in the processor and the third compute express link controller in the accelerator are configured to obtain the target data from the RNIC and cache the target data, and the first compute express link controller in the RNIC cooperates with the second compute express link controller in the processor and the third compute express link controller in the accelerator to complete the CXL function. The reason why the CPUs and accelerators cooperate with the RNIC through CXL is that CXL may improve the access performance of the CPUs and accelerators to RNIC data.

In specific implement, data with a volume less than the preset value may be offloaded to the processor or accelerator to better leverage the cache coherence function of CXL. Additionally, data with an access frequency greater than the preset access frequency, that is, hot data, may also be offloaded to the processor or accelerator, such as network protocol data packets and real-time data streams related to real-time network communication, so as to improve accuracy of processing remote direct memory access requests. Apparently, the target data may be the data that simultaneously meets conditions of having the volume less than the preset value and the access frequency greater than the preset access frequency.

The second remote direct memory access processing unit in the processor may be realized by pure software, and the third remote direct memory access processing unit in the accelerator may be realized by hardware, for example, the third remote direct memory access processing unit is realized by a field programmable gate array or an artificial intelligence dedicated controller.

In specific implement, the RNIC receives the remote direct memory access request. In some embodiments, after receiving the remote direct memory access request, it further includes: determining whether capacity expansion is required according to the remote direct memory access request; if the capacity expansion is required, executing a step of forwarding the remote direct memory access request to a processor or an accelerator in the server system; if the capacity expansion is not required, processing the remote direct memory access request based on the the internally cached data.

In specific implement, the RNIC determines whether capacity expansion is required according to an amount of data to be processed of the remote direct memory access request and load condition of the RNIC, and if the capacity expansion is required, forwards the remote direct memory access request to the processor or the accelerator for processing, if the capacity expansion is not required, processes the remote direct memory access request based on the internally cached data.

Furthermore, the RNIC forwards the remote direct memory access request to the processor or accelerator in the server system, and the processor or accelerator caches the data in the network interface card by compute express link, and processes the received remote direct memory access request based on the data.

In some embodiments, the step of forwarding the remote direct memory access request to the processor in the server system includes forwarding the remote direct memory access request to the processor in the server system by means of software messages.

In some embodiments, the step of forwarding the remote direct memory access request to the accelerator in the server system includes forwarding the remote direct memory access request to the accelerator in the server system by means of doorbell.

Furthermore, in addition to offloading RDMA service logic processing tasks of the RNIC, the CPUs and accelerators may also offload the congestion management tasks, queue pair (QP, Queue Pair, that is, send queues and receive queues) context management tasks, and RDMA caching on the RNIC.

Thus, the embodiment of the present application offloads the part of the functions of the RDMA processing unit in RNIC to the CPUs and accelerators, and when the processing capacity of the RNIC is insufficient, the data in the RNIC is cached by using CXL to expand the processing capacity of the RNIC. Compared with the related art, there is no need to replace or add the RNIC, thus realizing flexible capacity expansion of RNIC.

An application embodiment provided by the present application is described below. Using the function of CXL to cache accelerator data, the part of the functions of the RDMA processing unit in RNIC is offloaded to the CPUs and accelerators, and a CXL controller is added to the CPUs and accelerators, which completes data caching of RNIC by the CPUs and accelerators. A CXL controller is also added to the RNIC, which cooperates with the CXL controller added on the CPUs and accelerators to complete CXL function. The reason why the CPUs and accelerators cooperate with the RNIC through CXL is that CXL may improve the access performance of the CPUs and accelerators to RNIC data. In the example above, the CPUs and accelerators offload RDMA congestion management, RDMA cache and RDMA service logic processing. In actual situation, there should be more possibilities, such as offloading QP context management. In specific implement, data with a volume less than the preset value may be offloaded to the processor or accelerator to better leverage cache coherence function of CXL. Additionally, data with an access frequency greater than the preset access frequency, that is, hot data, may also be offloaded to the processor or accelerator, such as network protocol data packets and real-time data streams related to real-time network communication, so as to improve accuracy of processing remote direct memory access requests. Apparently, the target data may be data that simultaneously meets conditions of having a volume less than the preset value and an access frequency greater than the preset access frequency. An offloaded part of the CPUs is Soft-RDMA, which is pure software. The offloaded part of the accelerators is the RDMA processing unit, which is different according to different accelerators, such as a firmware of FPGA and a processing unit of AISC.

In terms of software architecture, the functions of RDMA driver are divided into: RNIC operation, RDMA capacity expansion management, a Soft RDMA agent and an accelerator agent. Among them, the RNIC operation is responsible for operation of RNIC registers. The RDMA capacity expansion management is responsible for related capacity expansion when processing capacity of RDMA is insufficient. The Soft RDMA agent is responsible for offloading part of functions of RDMA in RNIC to CPUs, and sending related RDMA requests to Soft RDMA modules in the CPUs through software messages. The accelerator agent is responsible for offloading part of functions of RDMA in RNIC to the accelerators, and sending related RDMA requests to the RDMA processing unit in the accelerators by means of doorbell.

In addition, there are CXL drivers and CXL device management modules in the software architecture to assist the CXL on the CPUs, the accelerators and the RNIC to run normally. A CXL driver is configured to start and operate CXL devices, which is the basis of CXL operation. The CXL device management module is configured to perform user management of CXL devices, such as checking the running status of CXL devices. The specific service process is shown in FIG. 5, including followings.

Step 1: a Rnic Receives a Rdma Request.

Step 2: a RDMA capacity expansion management module in a RDMA driver determines whether RDMA capacity expansion is required.

Step 3: if RDMA capacity expansion is not required, the RNIC handles independently.

Step 4: if RDMA capacity expansion is required, the RDMA capacity expansion management module hands over the RDMA request to a Soft RDMA agent and an accelerator agent.

Step 5: the Soft RDMA agent sends related RDMA requests to a Soft RDMA module in CPUs by means of software messages.

Step 6: the accelerator agent sends the related RDMA requests to a RDMA processing unit in accelerators by means of doorbell.

Step 7: the CPUs and accelerators cache some hot data in the RNIC through CXL.

Step 8: the CPUs and accelerators cooperate with the RNIC to complete RDMA processing.

A data processing apparatus provided by an embodiment of the present application is described below, and a data processing apparatus described below and a data processing method described above may be cross-referenced.

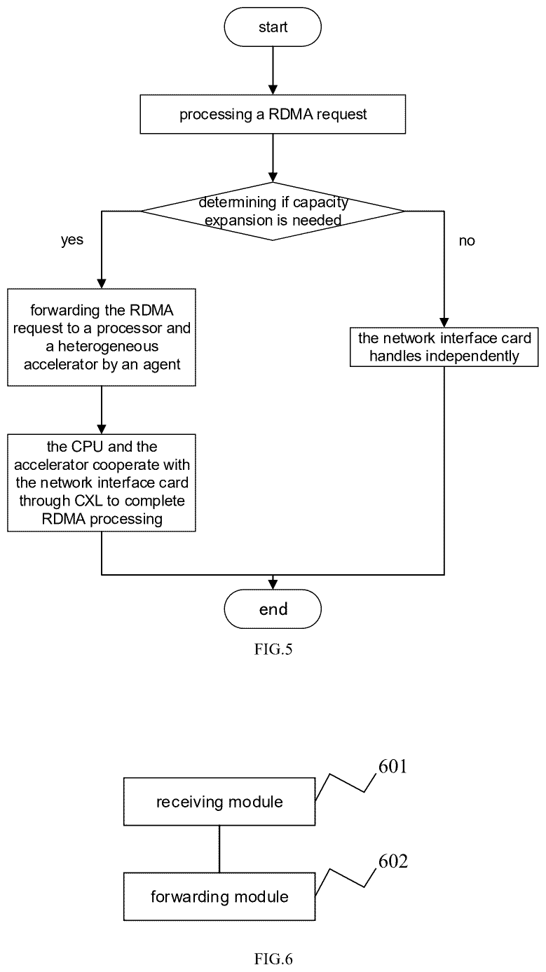

Referring to FIG. 6, a structural diagram of a data processing apparatus according to some embodiments of the present application, as shown in FIG. 6, includes:
a receiving module 601, configured to receive a remote direct memory access request;
a forwarding module 602, configured to forward the remote direct memory access request to a processor or an accelerator in a server system, so that the processor or the accelerator may obtain target data from a network interface card through compute express link, and process received remote direct memory access request based on the target data.

An execution subject of this embodiment is the network interface card in the above server system, which supports RDMA function, that is, the network interface card may be a RNIC. The server system includes a network interface card, a processor and an accelerator connected to the network interface card, wherein the network interface card includes a first remote direct memory access processing unit and a first compute express link controller, the processor includes a second remote direct memory access processing unit and a second compute express link controller, and the accelerator includes a third remote direct memory access processing unit and a third compute express link controller. The first compute express link controller is deployed in the network interface card, the second remote direct memory access processing unit and the second compute express link controller are deployed in the processor, and the third remote direct memory access processing unit and the third compute express link controller are deployed in the accelerator. The second compute express link controller in the processor and the third compute express link controller in the accelerator are configured to obtain the target data from the RNIC and cache the target data, and the first compute express link controller in the RNIC cooperates with the second compute express link controller in the processor and the third compute express link controller in the accelerator to complete the CXL function. The reason why the CPUs and accelerators cooperate with the RNIC through CXL is that CXL may improve the access performance of the CPUs and accelerators to RNIC data.

In specific implement, data with a volume less than the preset value may be offloaded to the processor or accelerator to better leverage cache coherence function of CXL. Additionally, data with an access frequency greater than the preset access frequency, that is, hot data, may also be offloaded to the processor or accelerator, such as network protocol data packets and real-time data streams related to real-time network communication, so as to improve accuracy of processing remote direct memory access requests. Apparently, the target data may be data that simultaneously meets conditions of having a volume less than the preset value and an access frequency greater than the preset access frequency.

The second remote direct memory access processing unit in the processor may be realized by pure software, and the third remote direct memory access processing unit in the accelerator may be realized by hardware, for example, the third remote direct memory access processing unit is realized by a field programmable gate array or an artificial intelligence dedicated controller.

Furthermore, the RNIC forwards the remote direct memory access request to the processor or accelerator in the server system, and the processor or accelerator caches the data in the network interface card by compute express link, and processes the received remote direct memory access request based on the data.

Thus, the embodiment of the present application offloads the part of the functions of the RDMA processing unit in RNIC to the CPUs and accelerators, and when the processing capacity of the RNIC is insufficient, the data in the RNIC is cached by using CXL to expand the processing capacity of the RNIC. Compared with the related art, there is no need to replace or add the RNIC, thus realizing flexible capacity expansion of RNIC.

In some embodiments, the apparatus further includes:
a determination module, configured to determine whether capacity expansion is required according to the remote direct memory access request; if capacity expansion is required, start a workflow of the forwarding module 602; if capacity expansion is not required, start a workflow of the processing module;
a processing module, configured to process the remote direct memory access request based on internally cached data.

In specific implement, the RNIC determines whether capacity expansion is required according to an amount of data to be processed of the remote direct memory access request and load condition of the RNIC, and if the capacity expansion is required, forwards the remote direct memory access request to the processor or the accelerator for processing, if the capacity expansion is not required, processes the remote direct memory access request based on the internally cached data.

In some embodiments, the forwarding module 602 is specifically configured to forward the remote direct memory access request to the processor in the server system by means of software messages.

In some embodiments, the forwarding module 602 is specifically configured to forward the remote direct memory access request to the accelerator in the server system by means of doorbell.

With regard to the apparatus in the above embodiments, the specific way in which each module performs operations has been described in detail in the embodiments of the method, and will not be described in detail here.

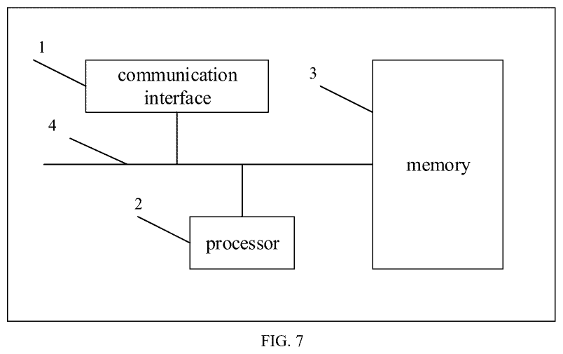

Based on hardware implementation of the above program modules, and in order to realize the method of the embodiments of the present application, the embodiment of the present application also provides an electronic device. FIG. 7 is a structural diagram of an electronic device shown in some embodiments of the present application, as shown in FIG. 7, the electronic device includes:
a communication interface 1, which may interact with other devices such as network devices;
a processor 2, connected to the communication interface 1 to realize information interaction with other devices, and configured to execute the data processing methods provided by one or more of the above technical solutions when running a computer program. And the computer program is stored on a memory 3.

Apparently, in practical application, various components in the electronic device are coupled together through a bus system 4. It may be understood that the bus system 4 is configured to realize connection communication between these components. The bus system 4 includes a power bus, a control bus and a status signal bus in addition to a data bus. However, for the sake of clarity, various buses are labeled as the bus system 4 in FIG. 7.

The memory 3 in the embodiment of the present application is configured to store various types of data to support operations of electronic device. Examples of such data include any computer program for operating on an electronic device.

It is understood that the memory 3 may be a transitory memory or a non-transitory memory, and may also include both transitory and non-transitory memories. Among them, the non-transitory memory may be read only memory (ROM), programmable read only memory (PROM), erasable programmable read only memory (EPROM), electrically erasable programmable read-only memory (EEPROM), ferromagnetic random access memory (FRAM), flash memory, magnetic surface memory, optical disk, or compact disc read-only memory; The magnetic surface memory may be a magnetic disk memory or a magnetic tape memory. The transitory memory may be a random access memory (RAM), which is used as an external cache. By means of illustration, but not limitation, many forms of RAM are available, such as static random access memory (SRAM), synchronous static random access memory (SSRAM), dynamic random access memory (DRAM), synchronous dynamic random access memory (SDRAM), double data rate synchronous dynamic random access memory (DDRSDRAM, Double data rate synchronous dynamic random access memory), enhanced synchronous dynamic random access memory (ESDRAM), SyncLink dynamic random access memory (SLDRAM), and direct rambus random access memory (DRRAM). The memory 3 described in the embodiment of the present application is intended to include, but is not limited to, these and any other suitable types of memories.

The method disclosed in the above embodiments of the present application may be applied to the processor 2 or realized by the processor 2. The processor 2 may be an integrated circuit with signal processing capability. In process of implementation, each step of the above method may be completed by hardware integrated logic circuits or software instructions in the processor 2. The above processor 2 may be a general processor, a DSP, or other programmable logic devices, discrete gate or transistor logic devices, discrete hardware components, etc. The processor 2 may implement or execute the methods, steps and logic blocks disclosed in the embodiments of the present application. The general processor may be a microprocessor or any conventional processor, etc. The steps of the method disclosed in the embodiment of the present application may be directly embodied as completion of execution by a hardware decoding processor or completion of execution by a combination of hardware and software modules in a decoding processor. The software module may be located in a storage medium, which is located in the memory 3. The processor 2 reads the program in the memory 3 and completes the steps of the above method in combination with its hardware.

When the processor 2 executes the program, it realizes corresponding flows in respective methods of the embodiments of the present application, and for the sake of brevity, they are not repeated here.

In an exemplary embodiment, the embodiment of the present application also provides a storage medium, that is, a computer storage medium, specifically a non-transitory computer readable storage medium, including, for example, a memory 3 storing a computer program, which may be executed by the processor 2 to complete the aforementioned method steps. The non-transitory computer readable storage medium may be FRAM, ROM, PROM, EPROM, EEPROM, Flash Memory, magnetic surface memory, optical disk, CD-ROM and other memories.

It may be understood by those skilled in the art that all or part of the steps of the above-mentioned method embodiments may be completed by hardware related to program instructions, and the above-mentioned program may be stored in a computer-readable storage medium, and when the program is executed, it executes the steps including the above-mentioned method embodiments; The aforementioned storage medium includes: mobile storage devices, ROM, RAM, magnetic disks or optical disks and other mediums that may store program codes.

Alternatively, if integrated units mentioned above are realized in form of software functional modules and sold or used as independent products, they may also be stored in a computer-readable storage medium. Based on this understanding, the technical solutions of the embodiments of the present application may, in essence or in their contribution to the prior art, be embodied in form of a software product, which is stored in a storage medium and includes several instructions to make an electronic device (such as a personal computer, a server, a network device, etc.) execute all or part of the methods of various embodiments of the present application. The aforementioned storage medium include: mobile storage devices, ROM, RAM, magnetic disks or optical disks and other media that may store program codes.

The above is only specific implement of the present application, but the protection scope of the present application is not limited to this. Any person skilled in the field may easily think of changes or substitutions within the technical scope disclosed in the present application, which should be covered by the present application. Therefore, the protection scope of the present application should be based on the protection scope of the claims.

1. A server system, comprising a network interface card, a processor and an accelerator, connected to the network interface card, wherein the network interface card comprises a first remote direct memory access processing unit and a first compute express link controller, the processor comprises a second remote direct memory access processing unit and a second compute express link controller, and the accelerator comprises a third remote direct memory access processing unit and a third compute express link controller;
the first remote direct memory access processing unit in the network interface card is configured to receive a remote direct memory access request and forward the remote direct memory access request to the processor or the accelerator;
the processor is configured to obtain target data from the network interface card through a communication between the second compute express link controller and the first compute express link controller, and process the received remote direct memory access request based on the target data by using the second remote direct memory access processing unit;
the accelerator is configured to obtain the target data from the network interface card through a communication between the third compute express link controller and the first compute express link controller, and process the received remote direct memory access request based on the target data by using the third remote direct memory access processing unit.

2. The server system according to claim 1, wherein the first remote direct memory access processing unit is configured to receive the remote direct memory access request, determine whether capacity expansion is required according to the remote direct memory access request, and if the capacity expansion is required, forward the remote direct memory access request to the processor or the accelerator.

3. The server system according to claim 2, wherein the first remote direct memory access processing unit is further configured to process the remote direct memory access request based on internally cached data in response to determining that the capacity expansion is not required according to the remote direct memory access request.

4. The server system according to claim 1, wherein the first remote direct memory access processing unit forwards the remote direct memory access request to the second remote direct memory access processing unit in the processor by means of a software message.

5. The server system according to claim 1, wherein the first remote direct memory access processing unit forwards the remote direct memory access request to the third remote direct memory access processing unit in the accelerator by means of a doorbell.

6. The server system according to claim 1, wherein the third remote direct memory access processing unit is a remote direct memory access processing unit implemented by a field programmable gate array or an artificial intelligence dedicated processor.

7. The server system according to claim 1, wherein the network interface card is further configured to forward congestion management tasks and/or queue pair context management tasks to the processor or the accelerator;
the processor is further configured to process the received congestion management tasks and/or queue pair context management tasks by using the second remote direct memory access processing unit;
the accelerator is further configured to process the received congestion management tasks and/or queue pair context management tasks by using the third remote direct memory access processing unit.

8. The server system according to claim 1, wherein the target data is data with a data amount less than a preset value and/or an access frequency greater than a preset access frequency.

9. The server system according to claim 1, wherein the network interface card comprises:
a remote direct memory access expansion management unit, configured to determine whether capacity expansion is required according to the remote direct memory access request;
a processor agent unit, configured to forward the remote direct memory access request to the processor when the capacity expansion is required;
an accelerator agent unit configured to forward the remote direct memory access request to the accelerator when the capacity expansion is required;
a remote direct memory access network interface card operation unit, configured to process the remote direct memory access request based on internally cached data when the capacity expansion is not required;
a compute express link device management unit, configured to manage compute express link devices in the network interface card; and
a compute express link driver, configured to perform startup and operations of the compute express link devices in the network interface card.

10. The server system according to claim 1, wherein the accelerator is a heterogeneous accelerator.

11. A data processing method, applied to the network interface card in the server system according to claim 1, the data processing method comprising:
receiving the remote direct memory access request;
forwarding the remote direct memory access request to the processor or the accelerator in the server system, so that the processor or the accelerator obtains the target data from the network interface card through compute express link, and process the received remote direct memory access request based on the target data.

12. The data processing method according to claim 11, wherein the target data is data with a data amount less than a preset value and/or an access frequency greater than a preset access frequency.

13. The data processing method according to claim 11, wherein after receiving the remote direct memory access request, the data processing method further comprises:
determining whether capacity expansion is required according to the remote direct memory access request;
if the capacity expansion is required, executing the step of forwarding the remote direct memory access request to the processor or the accelerator in the server system.

14. The data processing method according to claim 13, wherein determining whether the capacity expansion is required according to the remote direct memory access request comprises:
according to an amount of data to be processed of the remote direct memory access request and a load condition of the network interface card, determining whether the capacity expansion is required.

15. The data processing method according to claim 13, wherein after determining whether the capacity expansion is required according to the remote direct memory access request, the data processing method further comprises:
in response to determining that the capacity expansion is not required according to the remote direct memory access request, processing the remote direct memory access request based on internally cached data.

16. The data processing method according to claim 12, wherein forwarding the remote direct memory access request to the processor in the server system comprises:
forwarding the remote direct memory access request to the processor in the server system by means of a software message.

17. The data processing method according to claim 12, wherein forwarding the remote direct memory access request to the accelerator in the server system comprises:
forwarding the remote direct memory access request to the accelerator in the server system by means of a doorbell.

18. (canceled)

19. An electronic device, comprising:
a memory, configured to store a computer program; and
a processor, configured to implement steps of a data processing method when executing the computer program, wherein the data processing method is applied to a network interface card in a server system, the server system comprises the network interface card, a processor and an accelerator, and the method comprises:
receiving a remote direct memory access request;
forwarding the remote direct memory access request to the processor or the accelerator in the server system, so that the processor or the accelerator obtains target data from the network interface card through compute express link, and process the received remote direct memory access request based on the target data.

20. A non-transitory computer readable storage medium, wherein a computer program is stored on the non-transitory computer readable storage medium, and the computer program, when executed by a processor, implements steps of a data processing method, wherein the data processing method is applied to a network interface card in a server system, the server system comprises the network interface card, a processor and an accelerator, and the method comprises:
receiving a remote direct memory access request;
forwarding the remote direct memory access request to the processor or the accelerator in the server system, so that the processor or the accelerator obtains target data from the network interface card through compute express link, and process the received remote direct memory access request based on the target data.

21. The server system according to claim 9, wherein the processor agent unit is further configured to offload part of functions of remote direct memory access (RDMA) in an RDMA-enabled network interface card (RNIC) to the processor, and send related remote direct memory access requests to the second remote direct memory access processing unit in the processor by means of software messages; and the accelerator agent unit is further configured to offload part of functions of remote direct memory access in an RNIC to the accelerator, and send related remote direct memory access requests to the third remote direct memory access processing unit in the accelerator by means of the doorbell.
